(19) United States
(12) Patent Application Publication
(10) Pub. No.: US 2002/0088165 A1
(43) Pub. Date: Jul. 11, 2002

(54) Vibrating/rotating fish bait

(76) Inventor: Joseph J. Walencik, Harbor Springs, MI (US)

Correspondence Address: Joseph J. Walencik, 184 Mishe Mokwa, Harbor Springs, MI, 49740, US

(21) Appl. No.: 09/758,093

(22) Filed: Jan. 10, 2001

(51) Int. Cl. A01K 85/00

(52) U.S. Cl. 43/42.03

(57) ABSTRACT

To catch pan fish, varied small propellers with little vibration are used. This accomplished by mounting propeller on center in relation to hook shank plus having the propeller pitch the same on both blades. For predator fish larger propellers are used with more vibration. This is accomplished by mounting propeller off center in varied degrees in realness to hook shank. For maximum vibration, along with off center mounting the pitch of each blade on same propeller are varied. The more the pitch variation between each blade the more the vibration. NO SWIVEL ALONE can prevent line twist. To prevent this a hollow keel to accept swivel is employed, the size and angle of keel ear is such as to assist swivel to counter torque of propeller rotation thus preventing line twist. Without the two barbs on the fish hook shank whatever bait is used would slip into the curvature of the fish hook, thus adversely affecting the propeller action. Therefore bait must be kept parallel to hook shank to work properly. I have used this lure for several years with great success by tailoring the lure to match species of fish to be caught.

A fish bait that revolves and vibrates which may be cast, trolled, jigged, bottom fished, and still fished. It takes live and plastic bait and greatly enhances it, making it more attractive to fish.

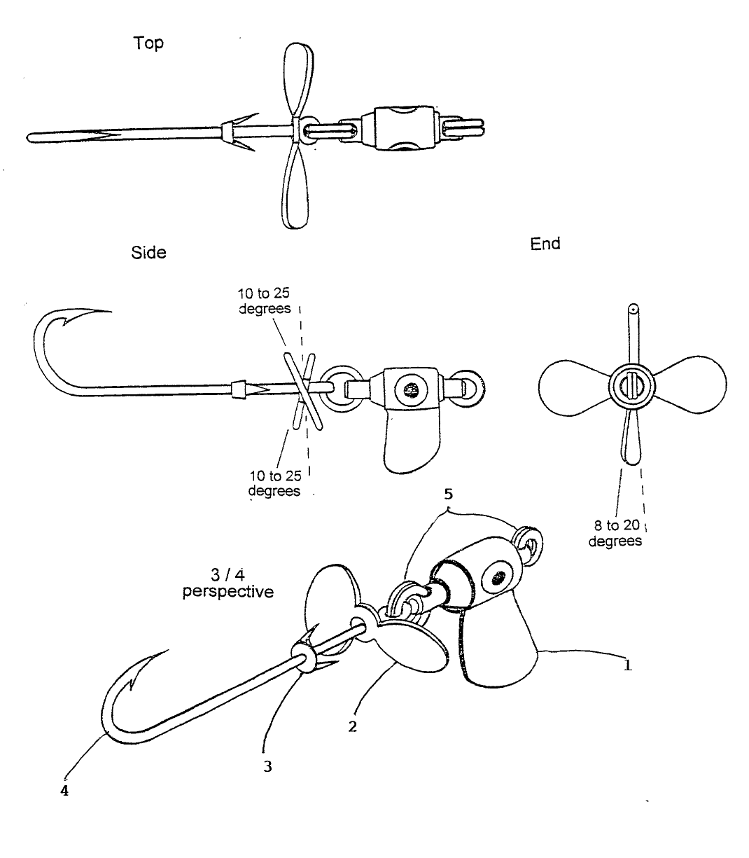

FIG. 1

a. keel is hollow to accept swivel.

b. keel is of varied sizes to counter torque of different size propellers.

c. keel is also on suitable angle to counter propeller torque.

d. keel is needed because no swivel alone will prevent line twist.

e. keel is made of plastic or metal.

FIG. 2

a. propeller made of plastic or metal.

b. mounted in permanent fashion adjacent to hook eye.

c. pitch may vary from blade to blade to get desired vibration.

d. propeller may be mounted off center or on center in relation to shank, to obtain desired vibration for size of bait.

FIG. 3

a. two pronged barb which is needed to keep bait parallel to shank.

b. is made of plastic or metal.

c. when minnows are used as bait, a single barb is employed.

d. if bait is not kept parallel to shank, it will neutralize the propeller action.

FIG. 4

a. fish hook of various sizes.

b. of various metal.

FIG. 5

a. swivels and two split rings.

b. inserted in cavity of keel.

FIG. 1

a. A hollow keel with one ear.

b. Made of plastic or metal.

c. Ear of keel of suitable size on suitable angle to prevent line twist.

d. The cavity of keel accepts swivel.

e. The keel ear and propeller must be in harmony to prevent line twist, this can only be accomplished by trial an error of each bait.

f. If size and angle of keel ear is too great, it will over compensate and cause line twist in opposite direction of propeller torque.

FIG. 2

a. The propeller consisting of two blades is made of plastic or metal and makes bait rotate.

b. The propeller is mounted in a permanent fashion adjacent to hook eye.

c. For minimum vibration of propeller, it is mounted on center in relation to hook shank.

d. For more vibration, which is desired on certain baits, the propeller is mounted off center in relation to hook shaft. The degree of eccentricity increases or decreases vibration.

e. For certain species of fish, maximum vibration is desired. This is accomplished by two different pitch on same propeller along with eccentric mounting of propeller in relation to hook shaft.

FIG. 3

a. The barbs are made of plastic or metal.

b. The barbs are necessary to keep bait parallel to hook shank.

c. Without barbs, whatever bait is used would slip into curvature of hook. In which case, the rotation and action of bait will be adversely affected.

FIG. 4

a. Fish hooks made of metal of which various sizes are used in relation to different size propellers and keels.

FIG. 5

a. Swivel and split rings on each end. One for hook and propeller, one for line attachment.

b. Whatever swivel is used must be balanced out with keel ear and propeller.

c. Each lure combination of propeller, keel, hook must be balanced out to perform in effective manner.

d. View of swivel is not shown because a variety of swivels may be used.

e. Each type of swivel has a different drag in its rotation. Swivels of same type have different drag in their rotation. Another reason to balance each lure by size and angle of keel ear.

What I claim as my invention is a fish lure I believe is better than any I have used:

1. I wish to seek a patent for the following components of the lure. The angular keel, the eccentric mounted propeller, and finally the barbs which keep bait parallel to shank.
I am a 78 year old veteran of W.W. II and have been fishing for 73 years. In this time, I have used many fish lures and rate mine as good as any.
I have been testing this lure for several years so that I do not base my conclusions without thorough testing.
After stating the foregoing, the bottom line is, does it catch fish and the answer is yes, using different sizes of this bait for different species.
